(19) United States
(12) Patent Application Publication
(10) Pub. No.: US 2001/0005272 A1
(43) Pub. Date: Jun. 28, 2001

(54) Optically actuated transducer system

(76) Inventor: Jeffrey C. Buchholz, Cross Plains, WI (US)

Correspondence Address: Donald J. Ersler, 725 Garvens Avenue, Brookfield, WI, 53005, US

(21) Appl. No.: 09/749,309

(22) Filed: Dec. 27, 2000

Related U.S. Application Data
(63) Continuation-in-part of application No. 09/110,763, filed on Jul. 3, 1998.

(51) Int. Cl. H04R 25/00

(52) U.S. Cl. 359/151; 381/172

(57) ABSTRACT

An optically actuated transducer system includes an audio signal source, a light emitter driver circuit, a light emitter, optical delivery device, and a transducer unit. An audio signal is fed into the light emitter driver circuit. The audio signal is fed into the light emitter driver circuit. The output of the light emitter is connected to the optical delivery device. The transducer unit includes a speaker membrane and an absorber layer. The absorber layer is applied to a back of the speaker membrane. An end of the fiber optic cable is positioned such that it contacts the absorber layer. The optical delivery device may also be brought in substantially parallel to the speaker membrane by transferring the light through an optical beam steering system. The absorber layer absorbs light from the light emitter and converts the light to heat. The heat produces a temperature rise that leads to thermal expansion of the absorber layer which forces the speaker membrane to make a linear motion and produce an acoustic output.

### CROSS-REFERENCE TO RELATED APPLICATIONS

This is a continuation-in-part patent application taking priority from, Ser. No. 09/110,763 filed on Jul. 3, 1998.

### BACKGROUND OF THE INVENTION

1. Field of the Invention

The present invention relates generally to thermally actuated transducers and more specifically to an optically actuated transducer system which is more reliable and less complex than that of the prior art.

2. Discussion of the Prior Art

Electromagnetic interference is a continual problem which plagues nearly every type of electronic device. Specifically, anytime current is run through a wire; electromagnetic energy is transmitted to the area surrounding the wire. Also, the wire will act as an antenna and receive electromagnetic energy from other electromagnetic sources. These problems are especially acute when there are other electronics in the vicinity of the wire. A second problem is security of the signal being transmitted through the wire; interception of the signal by enemy detection equipment is unacceptable. One way to suppress the electromagnetic interference is to use coaxial cable for the wire. This will help suppress electromagnetic interference, but will not totally eliminate it. A superior solution is the use of fiber optic cable for communication of the electronic signals.

There have been at least four attempts at utilizing a fiber optic cable to drive an acoustic transducer. U.S. Pat. No. 4,641,377 to Rush discloses a Photoacoustic Speaker and Method. The Rush patent utilizes a gas absorption chamber to actuate the speaker transducer. U.S. Pat. No. 4,002,897 to Kleinman et. al. discloses an Opto-Acoustic Telephone Receiver. The Kleinman patent utilizes a an optical absorption cell to produce sound to a human ear.

However, U.S. Pat. No. 4,503,564 to Fdelman et al. discloses a fiber optic cable with a spherical tip which radiates light energy across the entire surface area of a diaphragm. U.S. Pat. No. 4,766,607 to Feldman discloses a taut coupling attached to the membrane and a wire material.

Accordingly, there is a clearly felt need in the art for an optically actuated transducer system which produces audible sound for headphones or headsets without having to radiate light energy across the entire surface area of a diaphragm or have a taut coupling attached between the membrane and a wire material.

### SUMMARY OF THE INVENTION

The primary objective of the present invention is to provide an optically actuated transducer system which produces audible sound for headphones or headsets without unnecessary complexity. An optically actuated transducer system includes an audio signal source, a light emitter driver circuit, a light emitter, optical delivery device, and a transducer unit. An audio signal is fed into the light emitter driver circuit. Preferably, a laser diode is used as the light emitter. Regular light emitting diodes and other light sources may also be used. The light emitter is preferably biased with a 0.800 amp current when the voltage amplitude of the audio signal is zero. The audio signal fed into an operational amplifier will cause a transistor to modulate the current passing through the light emitter. The output of the light emitter is connected to the optical delivery device. The optical delivery device is preferably a fiber optic cable.

The transducer unit includes a transducer compartment and a membrane transducer assembly. The membrane transducer assembly preferably includes a speaker membrane, absorber layer, and mounting ring. The absorber layer is implemented by placing a small dot thereof on the speaker membrane. The periphery of the speaker membrane is attached to the mounting ring. The mounting ring is attached to a front of the transducer compartment. The transducer compartment also retains the fiber optic cable relative to the speaker membrane.

An end of the fiber optic cable is positioned such that thereof contacts the absorber layer on the speaker membrane. The fiber optic cable may also be brought in substantially parallel to the speaker membrane by transferring the light to the absorber layer through an optical beam steering system. The speaker membrane is preferably fabricated from a polymer plastic, but other suitable materials may also be used. The absorber layer is preferably a nickel foil or a layer of gallium arsenide, but other materials having suitable thermal and light absorption properties may also be used.

The absorber layer absorbs light from the light emitter and converts the light to heat. The heat produces a temperature rise that leads to thermal expansion of the absorber layer which forces the speaker membrane to make a linear motion away from the optical delivery point. As the voltage amplitude of the audio signal modulates, the amount of current passing through the light emitter modulates. The modulation of current produces a modulation of light energy. The modulating light energy causes the speaker membrane to have a successive linear motion which produces an acoustic output in the form of sound waves. The speaker membrane has sufficient acoustic output to replace an electrically actuated transducer in a headphone or headset.

Accordingly, it is an object of the present invention to provide an optically actuated transducer system which does not use an electrical transmission wire.

It is a further object of the present invention to provide an optically actuated transducer system which does not need to radiate light energy across entire surface area of a diaphragm.

It is yet a further object of the present invention to provide an optically actuated transducer system which does not require a taut coupling between the membrane and to a wire material.

It is yet a further object of the present invention to provide an optically actuated transducer system which has greater reliability than that of the prior art, because of a lack of sensitivity to optical and thermal properties of the membrane transducer itself.

Finally, it is another object of the present invention to provide an optically actuated transducer system which has greater reliability than that of the prior art, because of a smaller moving mass.

These and additional objects, advantages, features and benefits of the present invention will become apparent from the following specification.

### BRIEF DESCRIPTION OF THE DRAWINGS

FIG. 1 is a partial schematic diagram of an optically actuated transducer system in accordance with the present invention.

FIG. 2 is a schematic diagram of a preferable light emitter driver circuit in accordance with the present invention.

FIG. 3 is a side cross sectional view of a fiber optic cable directly coupled to a membrane transducer in accordance with the present invention.

FIG. 4 is a side cross sectional view of a fiber optic cable coupled to a membrane transducer through an optical beam steering system in accordance with the present invention.

### DETAILED DESCRIPTION OF THE PREFERRED EMBODIMENTS

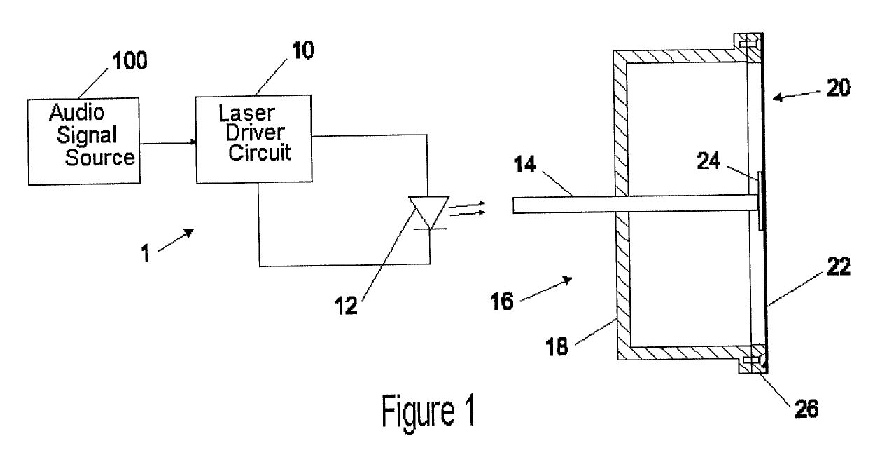

With reference now to the drawings, and particularly to FIG. 1, there is shown a partial schematic diagram of an optically actuated transducer system 1. An optically actuated transducer system 1 includes an audio signal source 100, a light emitter driver circuit 10, light emitter 12, optical delivery device, and transducer unit 16. The optical delivery device is preferably a fiber optic cable 14. The transducer unit 16 includes a transducer compartment 18 and a membrane transducer assembly 20. The membrane transducer assembly 20 preferably includes a speaker membrane 22, absorber layer 24, and mounting ring 26. The periphery of the speaker membrane 22 is attached to the mounting ring 26. The shape of the outer periphery of the speaker membrane is preferably round, but other suitable shapes may also be used. The mounting ring 26 is attached to a front of the transducer compartment 18. The transducer compartment 18 also retains the fiber optic cable 14 relative to the speaker membrane 22. The absorber layer 24 is implemented by placing a small dot thereof on the speaker membrane 22. The small dot of absorber layer 24 is preferably round or square. The size of the circle or square is preferably between 3 to 5 millimeters. Other designs of transducer units 16 may also be used. The membrane speaker 22 may also be attached directly to the transducer compartment 18 without the mounting ring 26.

The speaker membrane 22 is preferably fabricated from a polymer plastic, but other suitable materials may also be used. The absorber layer 24 is preferably fabricated from a thin foil either metallic or nonmetallic; a thin foil supported on a rigid support substrate, a thin slab of semiconductor, metallic laminate, nonmetallic laminate, or other materials having suitable thermal and light absorption properties. Any of the above absorber layers are preferably attached to the speaker membrane 22 with any suitable assembly method such as gluing with epoxy. Two materials which have been found satisfactory for the absorber layer are a nickel foil and gallium arsenide. The nickel foil has a preferable thickness of 0.0005 inches and the gallium arsenide has a preferable thickness of 0.015 inches.

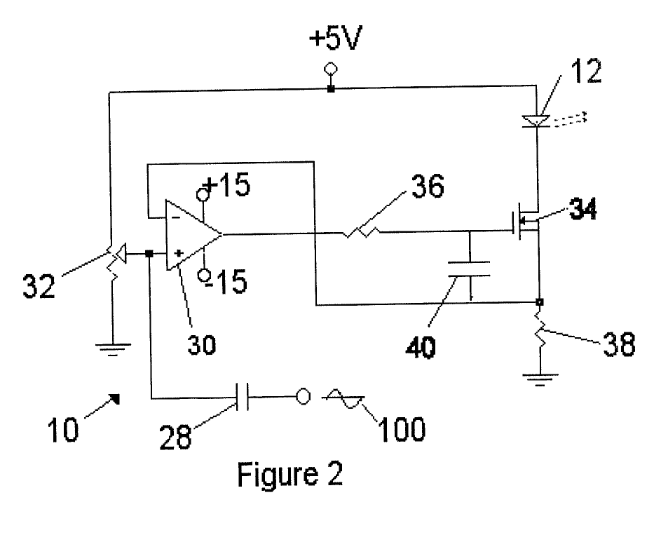

FIG. 2 shows a preferable light emitter driver circuit 10. The audio signal 100 passes through a capacitor 28 into the positive terminal of an operational amplifier 30. The capacitor 28 has a preferred value of 0.01 microfarads and strips the DC offset voltage from the audio signal 100. The potentiometer 32 is adjusted such that a DC offset voltage of preferably 0.80 volts is added to the audio signal 100. A potentiometer 32 has a preferred value of 10 kilohms. The operational amplifier 30 is preferably supplied by positive and negative voltage rails of 15 volts. The output of the operational amplifier 30 is coupled to a transistor 34 through a resistor 36.

The transistor 34 is preferably an n-channel mosfet transistor. The resistor 36 has a preferred value of 100 ohms. The source of the transistor 34 is coupled to ground through a bias resistor 38. The bias resistor 38 has a preferred value of 1 ohm. The bias resistor 38 provides a feedback voltage to the negative terminal of the operational amplifier 30. A filter capacitor 40 having a preferred value of 0.01 microfarads is connected from the gate to the source of the transistor 34. Other designs of light emitter driver circuits may also be used.

Preferably, a laser diode is used as the light emitter 12. Regular light emitting diodes and other light sources could also be used. A laser diode manufactured by the Spectra Physics corporation of Mountain View, Calif. has been found to have satisfactory performance characteristics. The laser diode has a maximum operating current of 1.365 amps and a maximum power output of 750 milliwatts. The light emitter 12 is connected to 5 volts DC and the drain of the transistor 34. The modulation of the audio signal 100 causes the transistor 34 to modulate the current passing through the light emitter 12. The modulation of current causes the light emitted from the light emitter 12 to modulate. The energy output of the light emitter 12 is preferably output through a 100 micron fiber optic cable. Fiber optic cables of other sizes may be used equally well if sufficient optical energy is coupled into the fiber optic cable.

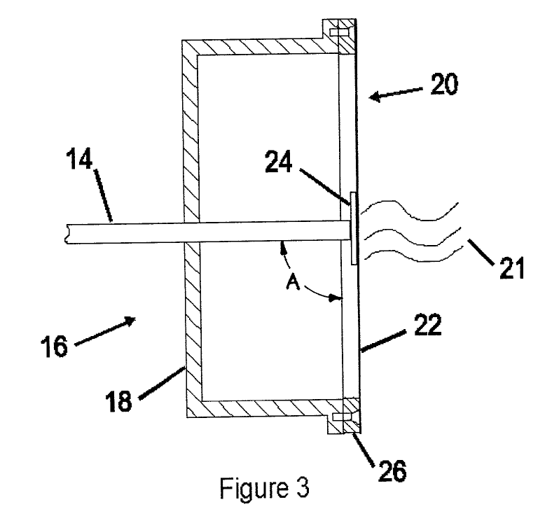

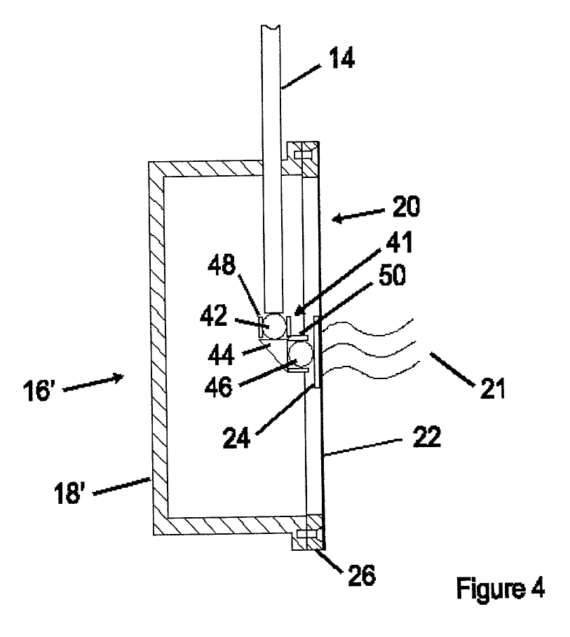

FIG. 3 shows an end of the fiber optic cable 14 positioned such that thereof contacts the absorber layer 24. The angle “A” of the fiber optic cable 14 relative to the membrane transducer assembly 20 is preferably normal, but may be any angle which provides for satisfactory operation. FIG. 4 shows an end of the fiber optic cable 14 positioned substantially parallel to the membrane transducer assembly 20. In FIG. 4, the light is transferred to the absorber layer 24 through an optical beam steering system 41. The optical beam steering system 41 enables the light to be redirected without having to bend the fiber optic cable 14. The optical beam steering system 41 includes a pair of ball lenses and a prism reflector 44.

The light from the end of the fiber cable 14 is focused through the first ball lens 42. The light is then reflected by the prism reflector 44 and refocused through the second ball lens 46 into the absorber layer 24. The second ball lens 46 must contact the absorber layer 24 for proper operation. The angle of reflection is preferably 90 degrees, but may be any other suitable angle. Preferably, the first ball lens 42 is contained within a first tube 48 and the second ball lens 46 is contained within a second tube 50. One end of the first tube 48 is bonded to the fiber optic cable 14 and the other end is bonded to one surface of the prism reflector 44. One end of the second tube 50 is bonded to another surface of the prism reflector 44 and the other end allows the second ball lens 46 to contact the absorber layer 24.

A transducer compartment 18′ is modified to retain the fiber optic cable 14 such that it is substantially parallel to the membrane transducer assembly 20. The substantially parallel fiber optic cable 14 allows a depth of the transducer compartment 18′ to be reduced.

The absorber layer 24 absorbs light from the light emitter 12 and converts the light to heat. The heat produces a temperature rise that leads to thermal expansion of the absorber layer 24 which forces the speaker membrane 22 to make a linear motion away from the optical delivery point. As the voltage amplitude of the audio signal modulates, the amount of current passing through the light emitter 12 modulates. The modulation of current produces a modulation of light energy. The modulating light energy causes the speaker membrane 22 to have successive linear motion which produces an acoustic output in the form of sound waves 21. The speaker membrane 22 has sufficient acoustic output to replace an electrically actuated transducer in a headphone or headset.

Dimensions, specifications, and materials are given by way of example and not by way of limitation.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. An optically actuated transducer system comprising:
a light emitter;
a light emitter driver circuit receiving an audio signal, said light emitter driver circuit modulating current to said light emitter;
a speaker membrane;
an absorber layer being applied to said speaker membrane; and
an optical delivery device receiving light from said light emitter on one end, the other end of said optical delivery device contacting said absorber layer, said absorber layer converting the light to heat, the absorber layer experiencing a thermal expansion, the thermal expansion causing the speaker membrane to make linear motion and produce an acoustic output.

2. The optically actuated transducer system of claim 1, wherein:
said optical delivery device being positioned such that the angle between a face of said speaker membrane and said optical delivery device is substantially perpendicular.

3. The optically actuated transducer system of claim 2, wherein:
said optical delivery device being a fiber optic cable.

4. The optically actuated transducer system of claim 1, further comprising:
a periphery of said speaker membrane being attached to a mounting ring, said mounting ring being attached to a transducer compartment, said transducer compartment retaining said optical delivery device.

5. The optically actuated transducer system of claim 1, wherein:
said speaker membrane being fabricated from a polymer plastic.

6. The optically actuated transducer system of claim 1, wherein:
said absorber layer being fabricated from a nickel foil.

7. The optically actuated transducer system of claim 1, wherein:
said absorber layer being fabricated from a layer of gallium arsenide.

8. An optically actuated transducer system comprising:
a light emitter;
a light emitter driver circuit receiving an audio signal, said light emitter driver circuit modulating current to said light emitter;
a fiber optic cable receiving light from said light emitter on one end;
a transducer unit including a speaker membrane and a transducer compartment;
an absorber layer being attached to said speaker membrane, said speaker membrane being attached to said transducer compartment, said transducer compartment retaining said fiber optic cable such that thereof contacts said absorber layer, said absorber layer converting the light to heat, the absorber layer experiencing a thermal expansion, the thermal expansion causing the speaker membrane to make linear motion and produce an acoustic output.

9. The optically actuated transducer system of claim 8, wherein:
said fiber optic cable being positioned such that the angle between a face of said speaker membrane and said optical delivery device is substantially perpendicular.

10. The optically actuated transducer system of claim 8, further comprising:
a periphery of said speaker membrane being attached to a mounting ring, said mounting ring being attached to said transducer compartment.

11. The optically actuated transducer system of claim 8, wherein:
said speaker membrane being fabricated from a polymer plastic.

12. The optically actuated transducer system of claim 8, wherein:
said absorber layer being fabricated from a nickel foil.

13. The optically actuated transducer system of claim 8, wherein:
said absorber layer being fabricated from a layer of gallium arsenide.

14. An optically actuated transducer system comprising:
a light emitter;
a light emitter driver circuit receiving an audio signal, said light emitter driver circuit modulating current to said light emitter;
a speaker membrane;
an absorber layer being applied to said speaker membrane;
an optical delivery device receiving light from said light emitter on one end; and
an optical beam steering system receiving light on one surface from said optical delivery device and reflecting said light at a different angle, another surface of said optical delivery device contacting said absorber layer, said absorber layer converting the light to heat, the absorber layer experiencing a thermal expansion, the thermal expansion causing the speaker membrane to make linear motion and produce an acoustic output.

15. The optically actuated transducer system of claim 14, wherein:
said optical steering system including a first ball lens, a second ball lens, and a prism reflector, light from said optical delivery device being focused through said first ball lens, the light being reflected by said prism reflector and refocused through said second ball lens into said absorber layer.

16. The optically actuated transducer system of claim 14, wherein:
said optical delivery device being positioned such that the angle between a face of said speaker membrane and said optical delivery device is substantially parallel.

17. The optically actuated transducer system of claim 16, wherein:
said optical delivery device being a fiber optic cable.

18. The optically actuated transducer system of claim 14, further comprising:
a periphery of said speaker membrane being attached to a mounting ring, said mounting ring being attached to a transducer compartment, said transducer compartment retaining said optical delivery device.

19. The optically actuated transducer system of claim 14, wherein:
said speaker membrane being fabricated from a polymer plastic.

20. The optically actuated transducer system of claim 14, wherein:
said absorber layer being fabricated from a nickel foil.

21. The optically actuated transducer system of claim 14, wherein:
said absorber layer being fabricated from a layer of gallium arsenide.
